(19) United States
(12) Patent Application Publication
(10) Pub. No.: US 2003/0140341 A1
(43) Pub. Date: Jul. 24, 2003

(54) Digital broadcast receiver and program guide display method thereof

(75) Inventor: Yasuo Nakashima, Kobe-shi (JP)

Correspondence Address: OLIFF & BERRIDGE, PLC, P.O. BOX 19928, ALEXANDRIA, VA, 22320, US

(73) Assignee: Fujitsu Ten Limited, Kobe-shi (JP)

(21) Appl. No.: 10/345,386

(22) Filed: Jan. 16, 2003

(30) Foreign Application Priority Data
Jan. 22, 2002 (JP) 2002-012693

(51) Int. Cl. G06F 3/00; H04N 5/445; G06F 13/00

(52) U.S. Cl. 725/44; 348/563; 725/39

(57) ABSTRACT

A program guide for each of service types such as television broadcasting and radio broadcasting contained in digital broadcasting waves receives at a digital broadcast receiver is formed and is displayed. A program guide Pa is a program guide of all service types of TV, radio, etc. A viewer watches program guides in order by operating horizontal scroll keys Kaa and Kab. If the viewer specifies “Radio” in a selection item field Ea on an operation screen Sa, a program guide Pb of only radio service of the service type specified is displayed.

The present disclosure relates to the subject matter contained in Japanese Patent Application No.2002-12693 filed on Jan. 22, 2002, which is incorporated herein by reference in its entirety.

### BACKGROUND OF THE INVENTION

1. Field of the Invention

This invention relates to a digital broadcast receiver and a program guide display method of a digital broadcast receiver for enabling a viewer to easily watch and operate his or her desired program guide so as to enhance the convenience of the viewer.

2. Description of the Related Art

Recently, a digital broadcast receiver for watching programs of multiple channels of satellite broadcasting, etc., has become widespread. In the digital broadcast receiver, a TS (Transport Stream) wherein data of a plurality of channels of television (TV) broadcasting is multiplexed is selected and is played back. An EPG (Electronic Program Guide) is added to the TS.

An electronic program guide for displaying the program contents in text information corresponding to broadcast time for each channel is known. The viewer can display the program guide on a display at any time and can watch the program contents. Media received at the digital broadcast receiver include broadcasting of a plurality of service types such as radio broadcasting and various data services in addition to TV broadcasting. The program contents of broadcasting of the service types can also be displayed on a display as a program guide. Thus, when digital broadcasting is watched and a program guide of each service type is displayed on the display, the program contents can be checked so that the advantage that service for the viewer is improved is provided.

The digital broadcasting waves of multiple channels contain a large number of programs for each of the service types. In a program guide in a related art, the display order is fixed. For example, first a normal TV program guide is displayed for each channel and next program guides of other service types such as radio broadcasting and extraordinary TV broadcasting are displayed in order. Thus, to search the program guide for any desired program, the viewer needs to scroll the screen several times and thus watching and operating of the program guide are intricate and also require time; this is a problem.

### SUMMARY OF THE INVENTION

It is therefore an object of the invention to provide a digital broadcast receiver and a program guide display method thereof for enabling a viewer to easily watch and operate his or her desired program guide for enhancing the convenience of the viewer.

To the end, according to a first aspect of the invention, there is provided a program guide display method of a digital broadcast receiver, the method includes the steps of displaying a program guide of digital broadcast wave, which includes a plurality of service types, and displaying a program guide of a specified service type, when the service type is specified.

Thus, the program guide of only the services involved in the objective service type specified by the viewer is displayed, so that the viewer can easily watch the program guide and can also simply perform operation for accessing his or her desired program guide.

According to the second aspect of the invention, there is provided a program guide display method of a digital broadcast receiver, the method including the steps of displaying a program guide of digital broadcast wave, which includes a plurality of service types, and displaying a program guide of a not-specified service type, when a service type is specified.

Thus, the program guide of the service not desired by the viewer is excluded, so that watching and operating of the program guide can be executed easily.

According to a third aspect of the invention, the method of the first aspect further includes the steps of displaying a program guide of a service type, which is a default service.

Thus, the viewer can easily watch and operate the programs of the same service type as the default service.

According to a fourth aspect of the invention, the method of the first aspect further includes the steps of displaying a program guide of a service, which belongs to the same service type as a service being selected, when a first button is turned on.

Thus, the viewer can easily watch and operate the service of the same type as the service being selected.

According to a fifth aspect of the invention, the method of the first aspect further includes the steps of switching the program guide of the displayed service type to a program guide of the remaining service types, when a second button is pushed.

Thus, the viewer can easily watch and operate program guides for the services of the remaining service types different from the service type being displayed.

According to a sixth aspect of the invention, the method of the first aspect further includes the steps of displaying the program guide in which the service types are arranged in order, when a third button is pushed.

Thus, when the viewer is conscious of the service type and watches and operates the program guide, the convenience of the viewer can be enhanced.

According to a seventh aspect of the invention, the method of the sixth aspect further includes the steps of displaying a program guide in order, which starts at a service type belonging to a default service, when a fourth button is pushed.

Thus, when the program guides are displayed in order according to the service type, the viewer can rapidly watch and operate service of the same service type as the default service.

According to an eighth aspect of the invention, the method of the sixth aspect further includes the steps of displaying a program guide of a service, which belongs to the same service type as a service being selected, when a first button is turned on.

Thus, when the program guides are displayed in order according to the service type, the viewer can rapidly watch and operate service of the same service type as the service being selected.

According to a ninth aspect of the invention, in the sixth aspect, the display order of the service types at a time the third button is pushed is settable.

Thus, any desired service display order can be set, so that a program guide can be prepared for display in response to the taste of the viewer.

According to a tenth aspect of the invention, the method of the sixth aspect further includes the steps of reversing the display order of the service types to display the program guide, when a fifth button is pushed.

Thus, the display order is reversed, whereby the viewer can easily watch and operate the program guide of service different from the service type being displayed.

According to a eleventh aspect of the invention, the method of the sixth aspect, further includes the steps of displaying a program guide of a service type being next to the current displayed service type, when a scroll key is operated in accordance with a predetermined rule.

Thus, the program guide is skipped for each service type, so that if a plurality of service types exist, the viewer can rapidly watch and operate the program guide.

According to a twelfth aspect of the invention, the method of the first aspect further includes the steps of displaying a program guide of a specified service group, when the service group is specified. The service group is a group in which a plurality of service types are grouped.

Thus, the service types are grouped, whereby the number of selection items that can be specified can be decreased and the viewer can specify service type easily.

According to a thirteenth aspect of the invention, the method of the second aspect further includes the steps of displaying a program guide of a not-specified service group, when the service group is specified. The service groups are groups in which a plurality of service types are grouped.

Thus, when the service types are grouped, a program guide in which the services in the service group to be not watched are omitted is displayed, so that the viewer can easily watch and operate the program guide.

According to a fourteenth aspect of the invention, the method of twelfth aspect further includes the steps of displaying a program guide in order, which starts at a service group belonging to a default service, when a fourth button is pushed.

Thus, when the service types are grouped, the program guide of the same service group as the default service on the reception channel is displayed, so that the viewer can rapidly watch and operate the program guide of the same service group as the default service.

According to a fifteenth aspect of the invention, the method of the twelfth aspect further includes the steps of displaying a program guide of a service, which belongs to the same service group as a service being selected, when a first button is turned on.

Thus, when the service types are grouped, the program guide of the same service group as the service being selected is displayed, so that the viewer can rapidly watch and operate the program guide of the same service group as the service being selected.

According to a sixteenth aspect of the invention, the method of the twelfth aspect further includes the steps of switching the program guide of the displayed service group to a program guide of the remaining service groups, when a second button is pushed.

Thus, when the service types are grouped, the viewer can easily watch and operate program guides for the remaining service groups different from the service group being displayed.

According to a seventeenth aspect of the invention, the method of twelfth aspect further includes the steps of displaying the program guide in which the service groups are arranged in order, when a third button is pushed.

Thus, the program guide arranged for each service group is displayed, so that when the viewer is conscious of the service group and watches and operates the program guide, the convenience of the viewer can be enhanced.

According to an eighteenth aspect of the invention, the method of the seventeenth aspect further includes the steps of displaying a program guide in order, which starts at a service group belonging to a default service, when a fourth button is pushed.

Thus, when program guides are displayed in order for each service group of services grouped for each service type, the viewer can rapidly watch and operate the program guide of the same service group as the default service.

According to a nineteenth aspect of the invention, the method according to the seventeenth aspect further includes the steps of displaying a program guide of a service, which belongs to the same service group as a service being selected, when a first button is turned on.

Thus, when program guides are displayed in order for each service group of services grouped for each service type, the viewer can rapidly watch and operate the program guide of the same service as the service group being selected.

According to a twentieth aspect of the invention, in the seventeenth aspect, the display order of the service types at a time the third button is pushed is settable.

Thus, when program guides are displayed in order for each service group of services grouped for each service type, any desired service display order can be set, so that a program guide can be prepared for display in response to the taste of the viewer.

According to a twenty-first aspect of the invention, the method of the seventeenth aspect further includes the steps of reversing the display order of the service groups to display the program guide, when a fifth button is pushed.

Thus, when program guides are displayed in order for each service group of services grouped for each service type, the display order is reversed, whereby the viewer can easily watch and operate the program guide of service different from the service type being displayed.

According to a twenty-second aspect of the invention, the method of the seventeenth aspect further includes the steps of displaying a program guide of a service group being next to the current displayed service group, when a scroll key is operated in accordance with a predetermined rule.

Thus, when program guides are displayed in order for each service group of services grouped for each service type, the program guide is skipped for each service type, so that if a plurality of service types exist, the viewer can rapidly watch and operate the program guide.

According to a twenty-third aspect of the invention, in the seventeenth aspect, user can set the service group.

Thus, the viewer sets the service group by his or her determination, so that the viewer can prepare program guides as he or she desires considering the mode required by the viewer, the ease of use, etc.

According to a twenty-fourth aspect of the invention, there is provided a digital broadcast receiver including a central processing unit, an input section from which user inputs an instruction, and a display. The central processing unit makes the display to display a program guide of digital broadcast wave, which includes a plurality of service types. The central processing unit makes the display to display a program guide of a specified service type, when the instruction by the user is specification of a service type.

### BRIEF DESCRIPTION OF THE DRAWINGS

In the accompanying drawings:

FIG. 1 is a schematic representation to show program guides of programs received at digital broadcast receiver according to embodiment of the invention;

FIG. 2 is a schematic representation to show the types of program services;

FIG. 3 is a schematic representation to show a configuration example of program services;

FIG. 4 is a schematic representation to show a configuration example of program services;

FIG. 5 is a schematic representation to show an example of program guide of the invention;

FIG. 6 is a schematic representation to show an example of program guide of the invention;

FIG. 7 is a schematic representation to show an example of program guide of the invention;

FIG. 8 is a schematic representation to show an example of program guide of the invention;

FIG. 9 is a schematic representation to show an example of program guide of the invention;

FIG. 10 is a schematic representation to show an example of program guide of the invention;

FIG. 11 is a schematic representation to show an example of program guide of the invention;

FIG. 12 is a schematic representation to show a processing example of the invention;

FIG. 13 is a schematic representation to show an example of program guide of the invention;

FIG. 14 is a schematic representation to show an example of program guide of the invention;

FIG. 15 is a schematic representation to show an example of service grouping;

FIG. 16 is a schematic representation to show a service configuration example;

FIG. 17 is a schematic representation to show a service configuration example;

FIG. 18 is a schematic representation to show an example of program guide of the invention;

FIG. 19 is a schematic representation to show a processing example of the invention; and

FIG. 20 is a block diagram to show digital broadcast receiver according to embodiment of the invention.

### DETAILED DESCRIPTION OF THE PREFERRED EMBODIMENTS

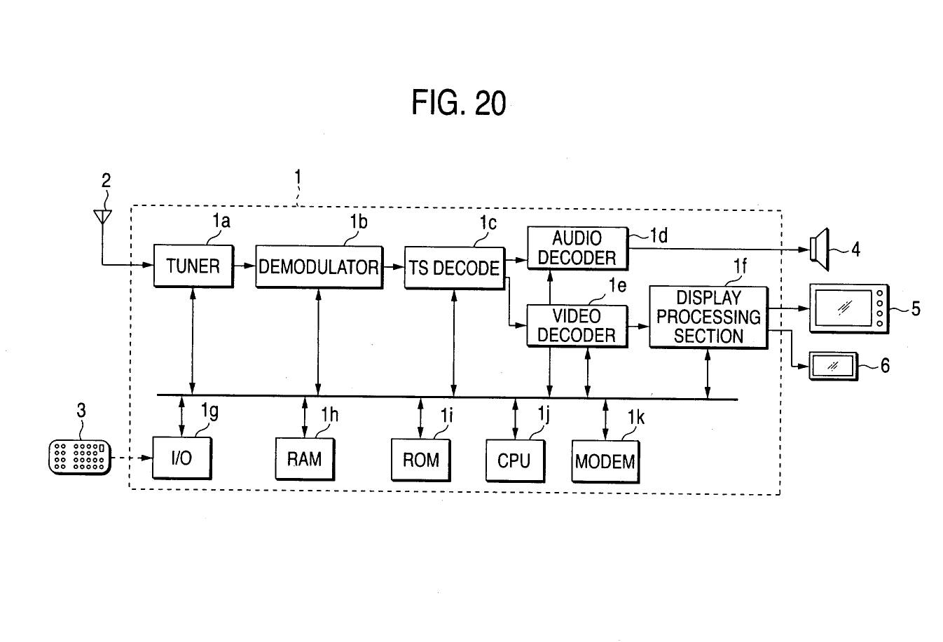

Referring now to the accompanying drawings, there are shown preferred embodiments of the invention. FIG. 20 is a block diagram to show an example of a digital broadcast receiver into which the invention is incorporated. In FIG. 20, a digital broadcast receiver 1 receives digital broadcast waves at an antenna 2. The digital broadcast receiver 1 includes a tuner 1a and one broadcast wave is selected as the receiver 1 is tuned by the tuner 1a.

The broadcast wave selected by the tuner 1a is demodulated by a demodulator 1b in 64 QAM (Quadrature Amplitude Modulation) system, etc. The signal demodulated by the demodulator 1b is then separated into an MPEG audio signal and an MPEG video signal by a TS decoder 1c. Further, the MPEG audio signal and the MPEG video signal are decoded by an audio decoder 1d and a video decoder 1e. The MPEG audio signal is output from an output terminal to a loudspeaker 4. The MPEG video signal is subjected to display processing by a display processing section 1f and is output from an output terminal to a main display 5.

The digital broadcast receiver 1 also includes an input/output interface I/O 1g, RAM 1h, ROM 1i, a CPU (Central Processing Unit) 1j, and a modem 1k. A signal from an operation section 3 of a remote control key, etc., is detected in the I/O 1g and the digital broadcast receiver 1 is turned on or off or the corresponding channel is selected.

Program guides in various formats prepared by the viewer whenever necessary as described later are registered in the RAM 1h. A management program for operating the digital broadcast receiver 1 and the like are stored in the ROM 1i. The CPU 1j controls the operation of the digital broadcast receiver 1 by a predetermined program. The modem 1k codes and decodes an external signal. Various messages, etc., are displayed on a subdisplay 6.

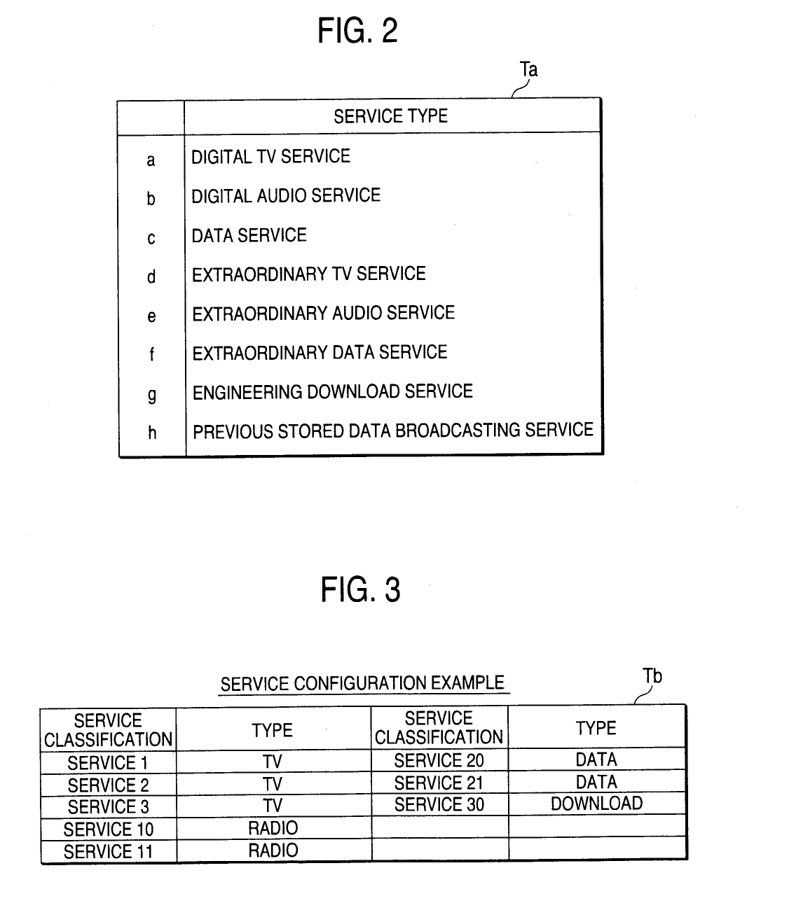

FIG. 2 is a schematic representation to show definition of the types of services in BS digital broadcasting as a table Ta. As shown in FIG. 2, a “digital TV service”, b “digital audio service”, c “data service”, d “extraordinary TV service,” e “extraordinary audio service”, f “extraordinary data service”, g “engineering download service”, and h “previously stored data broadcasting service” are defined as the types of services in BS digital broadcasting. The letters a to h are put for convenience of the description.

Thus, a plurality of service types for each of different media such as TV, audio (radio), and data are defined. A program guide is prepared for each of the service types a to h. Since the program guides are displayed on the display in order, the viewer needs to scroll the screen several times until he or she finds out a program of the service type desired by the viewer. Thus, the operation is intricate and it also takes time in watching the program guides. In the invention, the program guide containing various service types as described above is edited so that the viewer can easily operate and watch the program guide.

FIG. 3 is a schematic representation to show an example of a table Tb edited by sorting the types of services of digital broadcasting received by the digital broadcast receiver 1 according to media of the same contents. As shown in FIG. 3, TV is allotted as the service type to service classification of services 1 to 3. Radio is allotted to service classification of services 10 and 11, data is allotted to service classification of services 20 and 21, and download is allotted to service classification of service 30.

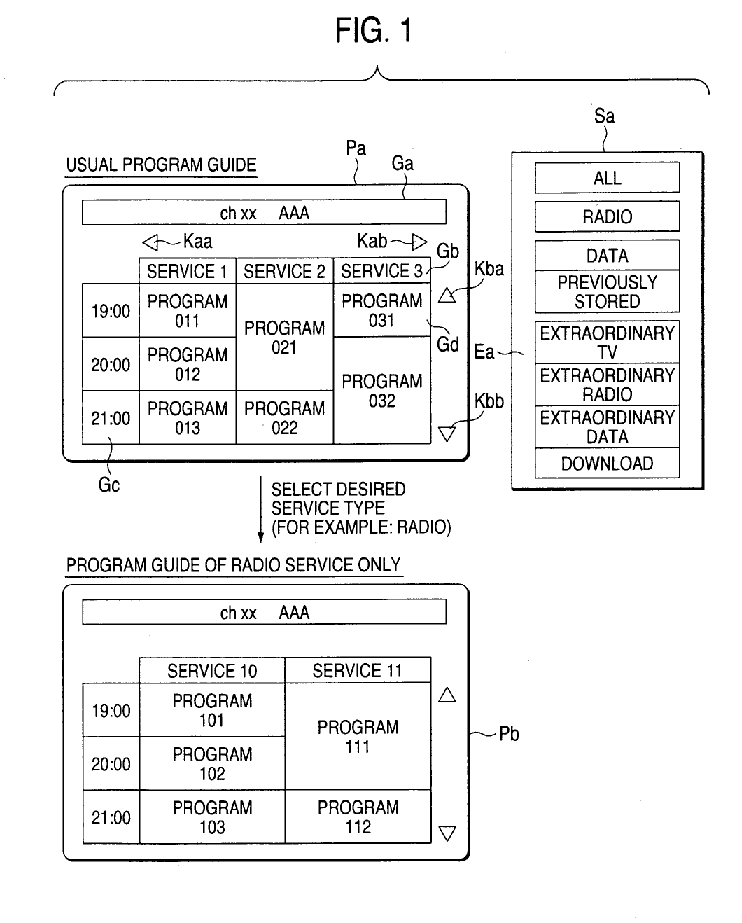

FIG. 1 is a schematic representation to show an example wherein a program guide edited based on the table in FIG. 3 is displayed and the viewer specifies his or her desired service type to display the program guide corresponding to the specified service type. In FIG. 1, a program guide Pa is displayed on the screen. Channel number xx and broadcast station name AAA are displayed in a GA area of the screen. In a Gb area, services 1 to 30 of the service classification are arranged collectively for each service type such as TV or radio. The viewer can access his or her desired service type by operating left and right horizontal scroll keys Kaa and Kab.

Broadcast times are displayed in a Gc area. The viewer can access his or her desired time by operating up and down vertical scroll keys Kba and Kbb. In the intersections of the broadcast times and the service classification, the broadcast program contents are displayed in text in a Gd area. The example in FIG. 1 shows that program 031 will be broadcast starting at 19:00 at TV of service 3.

The service types are set in order for each of media of the same contents such as TV or radio as in FIG. 3, whereby if the viewer operates the left and right horizontal scroll keys Kaa and Kab in FIG. 1, the program guide of the service types of the same contents are displayed collectively in order in such a manner that first the program guide corresponding to the service type TV is displayed and next the program guide corresponding to the service type radio is displayed. This eliminates random display of the program guides of different media in such a manner that the service type TV is followed by radio, followed by extraordinary TV, and program guide easily seen by the viewer can be provided.

A selection item field Ea for the viewer to select his or her desired service type for displaying program guide of the service is displayed on an operation screen Sa in FIG. 1. The selection item field Ea may be implemented as touch switch. If the viewer specifies “All” in the selection item field Ea, the program guides are displayed for all broadcast services. If the viewer specifies one of the selection items, the program guides of only the specified service is displayed. FIG. 1 assumes that the viewer specifies selection item “Radio” on the operation screen Sa in a state in which the program guide Pa is displayed.

In this case, the program guide Pa is switched to a program guide Pb, and only the programs of services 10 and 11 of radio broadcasting are displayed in the program guide Pb. Since the program guide including only the service concerning the service type specified by the viewer is thus displayed, the viewer can easily watch the program guide and can also simply perform operation for accessing his or her desired program guide.

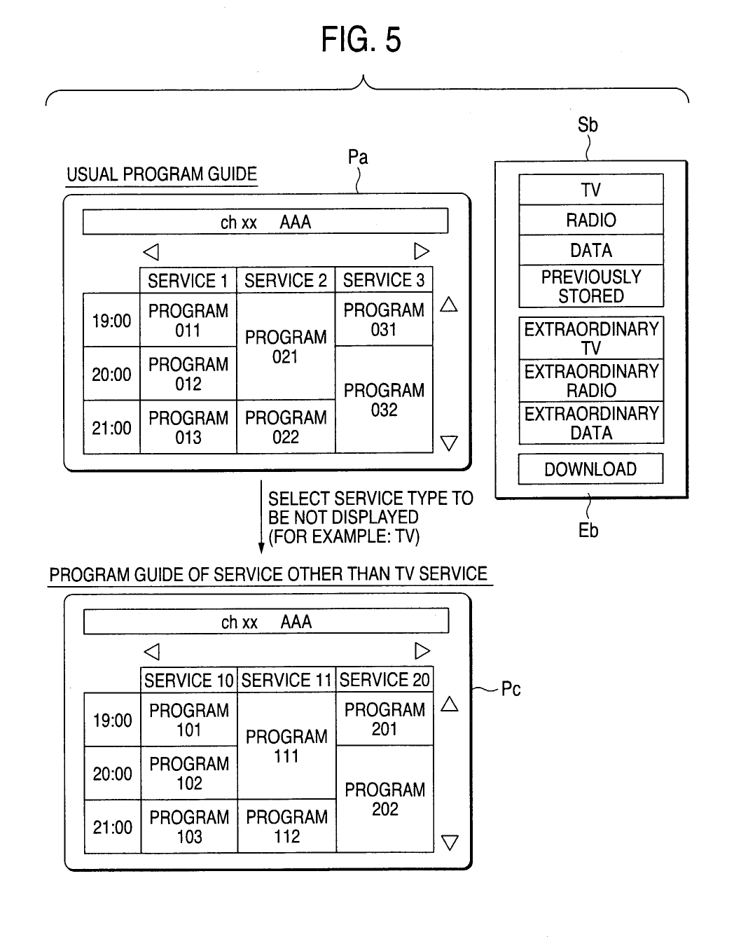

FIG. 5 is a schematic representation to show another embodiment of the invention. Program guide Pa is the same as that in FIG. 1. A selection item field Eb to select service not to be displayed is displayed on an operation screen Sb. If the viewer selects “TV” in the selection item field Eb, the program guide Pa is switched to a program guide Pc. In the displayed program guide Pc, the service type TV is excluded and the viewer can watch program guides of the service types except TV by operating left and right scroll keys. In the example in FIG. 5, programs of the service not desired by the viewer are thus excluded, so that watching and operating of the program guide can be executed easily. A plurality of services that are excluded may be set.

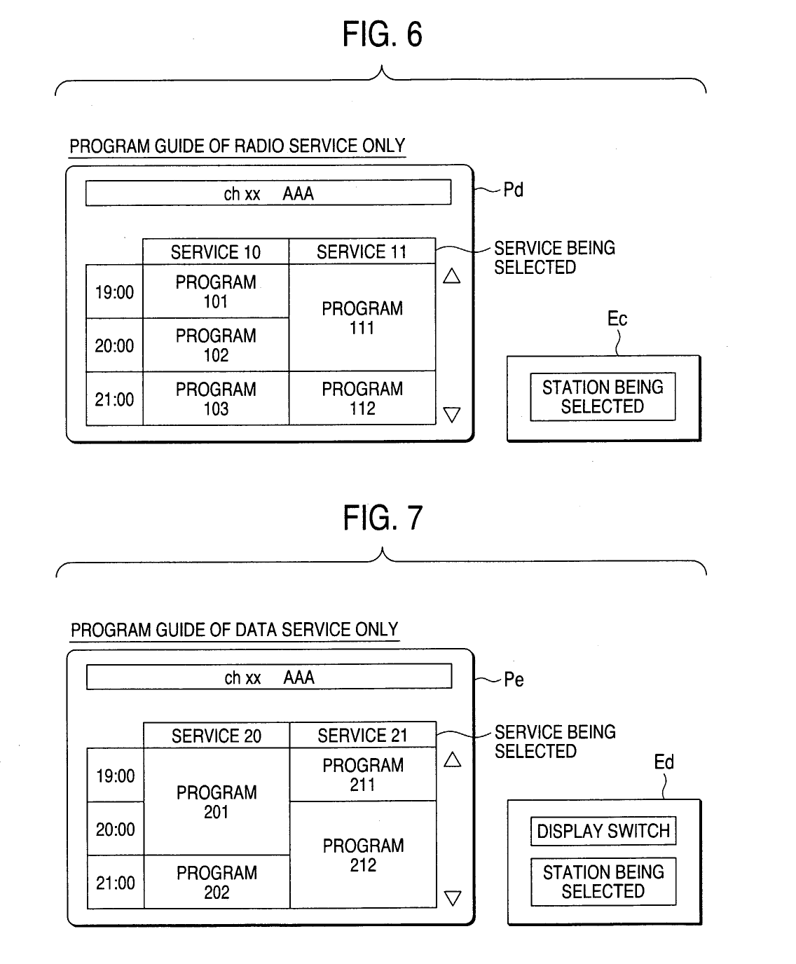

FIG. 6 is a schematic representation to show another embodiment of the invention. In the example in FIG. 6, program guide Pd of default service is displayed on reception channel. The default service refers to service automatically selected first when the reception channel is selected. The default service can be set as desired; for example, the service with the smallest service classification number or the like may be set as the default service. In the example in FIG. 6, “Radio” with service classification 10 is set as the default service. At this time, programs of service 11 of the same service type as the default service are displayed.

“Station being selected” is displayed as a selection item Ec on an operation screen. If the viewer touches “Station being selected” and specifies service 11, the service 11 being selected is highlighted by being displayed differently from any other service in such a manner that the foreground or background color of service 11 is reverse-displayed. Accordingly, in the example in FIG. 6, the programs of the same service type as the default service are displayed, so that the viewer can easily watch and operate the programs of the same service type as the default service.

FIG. 7 is a schematic representation to show another embodiment of the invention. In the example in FIG. 7, when the program guide Pa previously described with reference to FIG. 1 is displayed, the viewer touches “Station being selected” in a selection item field Ed on an operation screen. Assuming that service 21 is the service being selected. The service 21 is data service. Thus, data services of services 20 and 21 belonging to the same service type are displayed as a program guide Pe.

At this time, the service 21 being selected may be highlighted to be displayed differently from any other service in a similar manner to that in FIG. 6. In the example in FIG. 7, the service of the same type as the service being selected is displayed, so that the viewer can easily watch and operate the service of the same type as the service being selected. In the processing previously described with reference to FIG. 6, 7, a selection item of “display switch” as shown in FIG. 7 may be set on the operation screen for switching display from the program guide Pa in FIG. 1 to the program guide Pd, Pe.

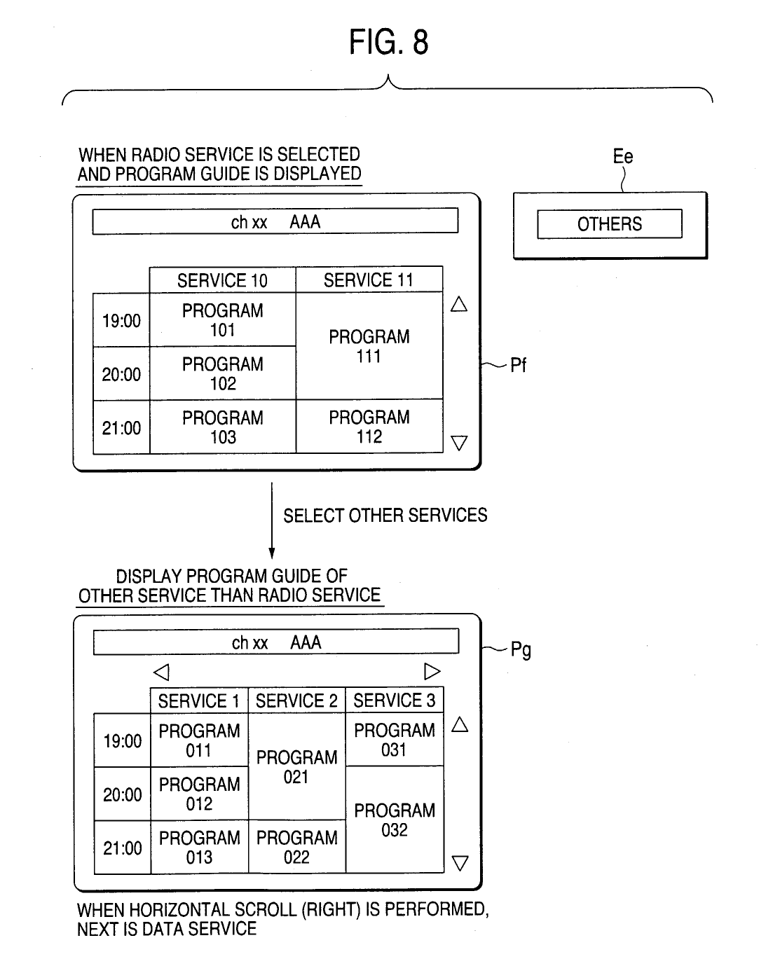

FIG. 8 is a schematic representation to show another embodiment of the invention. In the example in FIG. 8, radio service is selected and program guide Pf is displayed. Here, if the viewer selects “Others” of a selection item Ee out of an operation screen, program guide Pg of service other than the radio service is displayed. Services 1 to 3 belonging to the service type of TV service are displayed in the program guide Pg. If the viewer operates a right scroll key Kab in this state, a program guide of services 20 and 21 of the data service next to the TV service of service other than the radio service shown in FIG. 3 is displayed. In the example in FIG. 8, the viewer can easily watch and operate program guides for the remaining service groups different from the service group being displayed.

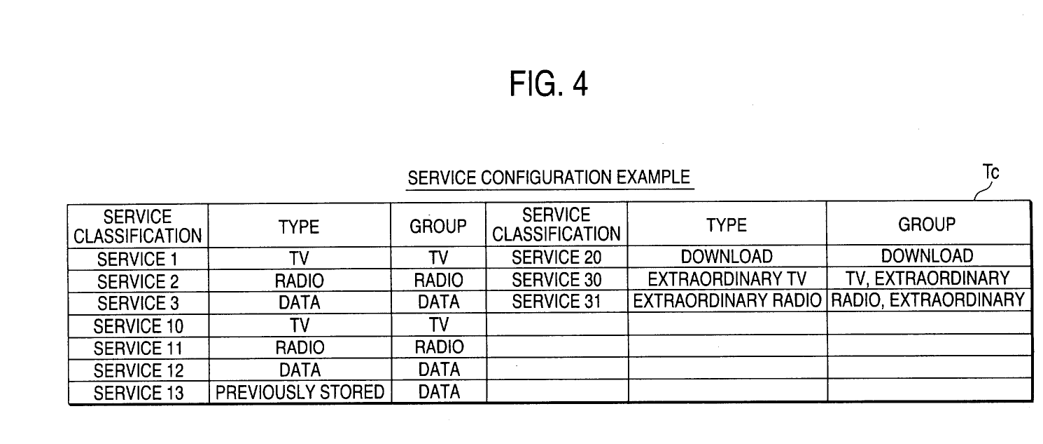

FIG. 4 is a schematic representation to show an example of a table Tc of program guide wherein different media such as radio and data are set at random as the service types corresponding to services 1 to 31 of service classification and the service classification numbers and the service types are allotted out of order.

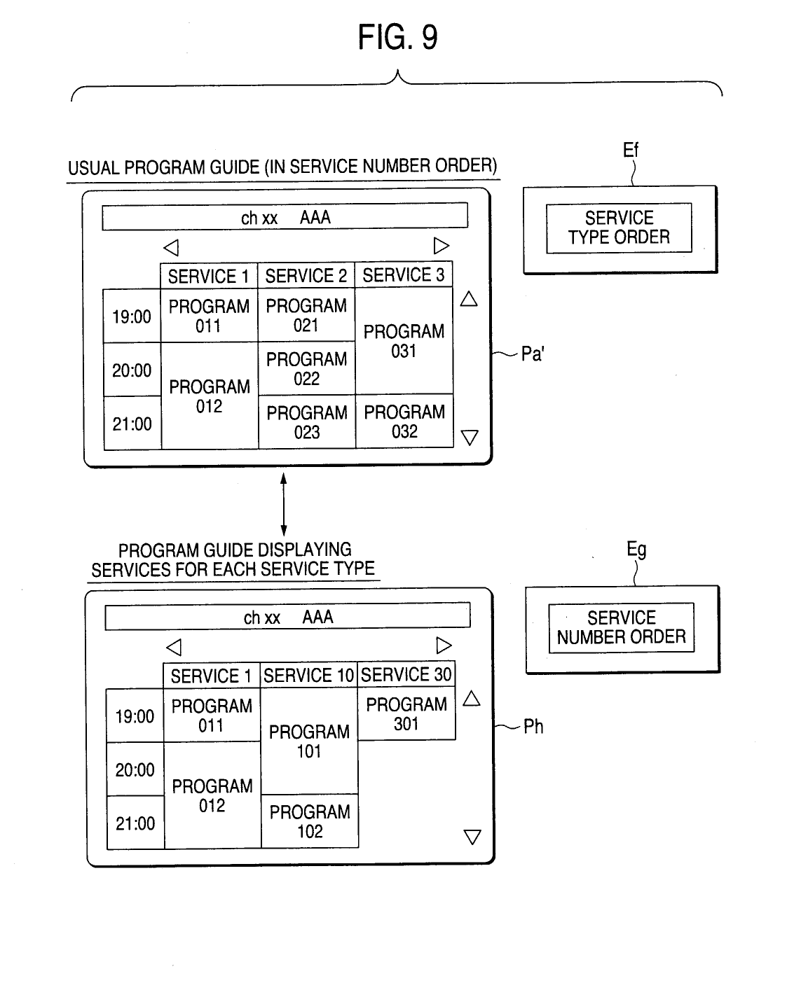

In the invention, the program guide wherein the media are set at random as in FIG. 4 can be changed to a program guide in a format easily watched and operated by the viewer for display. FIG. 9 is a schematic representation to show an example wherein the order is changed for the service configuration in FIG. 4 for display.

In FIG. 9, program guide Pa′ displays services 1 to 31 in the service classification number order in FIG. 4 when the viewer selects “Service number order” of a selection item Eg. Here, if the viewer selects “Service type order” of a selection item Ef, program guide Ph for each service type is displayed.

In the example in FIG. 9, in the program guide Ph, the programs of each service type such as radio or data are collected in order starting at the service type TV and are displayed in the service classification number order. Thus, in the example in FIG. 9, the program guide arranged for each service type is displayed. Thus, when the viewer is conscious of the service type and watches and operates the program guide, the convenience of the viewer can be enhanced.

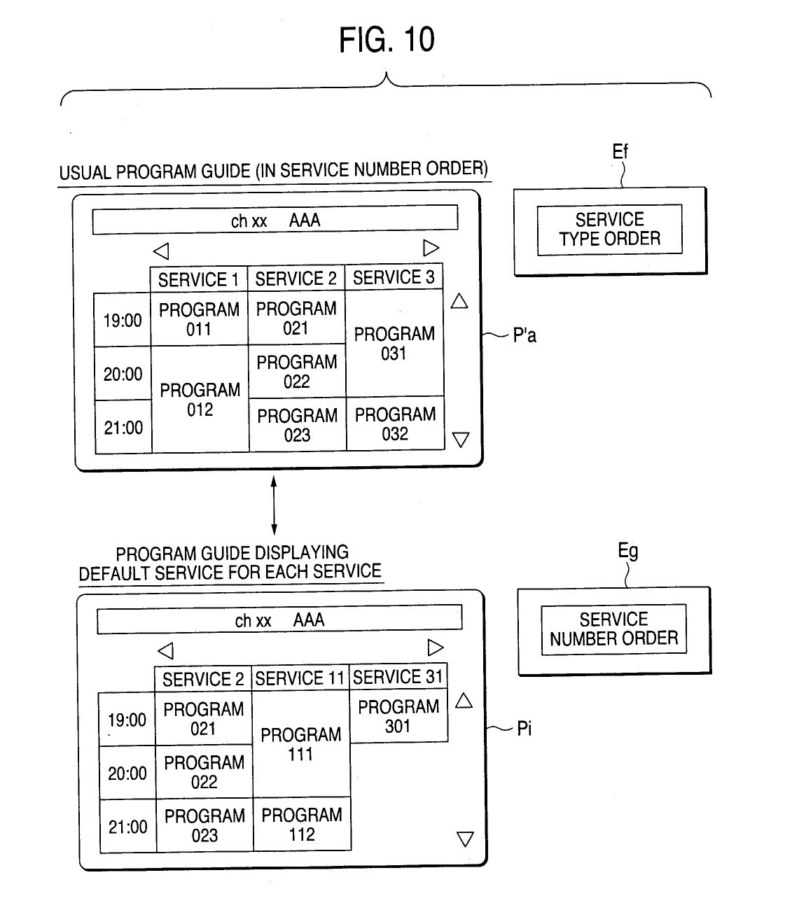

FIG. 10 is a schematic representation to show another example wherein the order is changed for the service configuration in FIG. 4 for display. In FIG. 10, when the viewer sets service 2 to the default service, if he or she selects the service type order of the selection item Ef, the program guide Pa′ is switched to program guide Pi.

Here, since the service classification of service 2 is radio service as shown in FIG. 4, the program guide Pi displays the programs of services 11 and 31 belonging to the same service type as the default service. In the example in FIG. 10, the program guide of the same service type as the default service is thus displayed, so that the viewer can rapidly watch and operate service of the same service type as the default service.

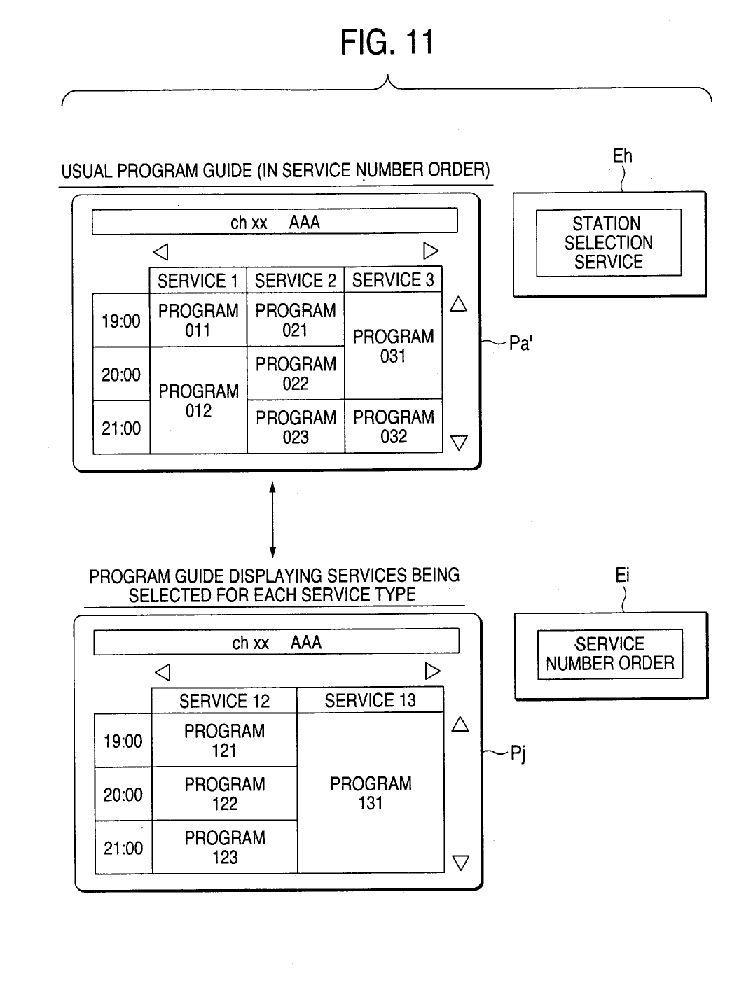

FIG. 11 is a schematic representation to show another example wherein the order is changed for the service configuration in FIG. 4 for display. Assuming that in FIG. 11, station selection service of a selection item Eh is selected and service being selected is service 12. Similarly to the other embodiments, when the viewer selects the service type in a selection item Eh, the program guide Pa′ is switched to program guide Pj. It is noted that although the service 12 is not shown in FIG. 11 (the program guide Pa′), the service 12 is displayed when the program guide Pa′ is scrolled laterally.

Here, service 13 corresponds to the service type, previously stored, and belongs to the same data service type as service 12 being selected. Thus, in the example in FIG. 11, the program guide of the same service type as the service being selected is displayed. Thus, the viewer can rapidly watch and operate service of the same service type as the service being selected.

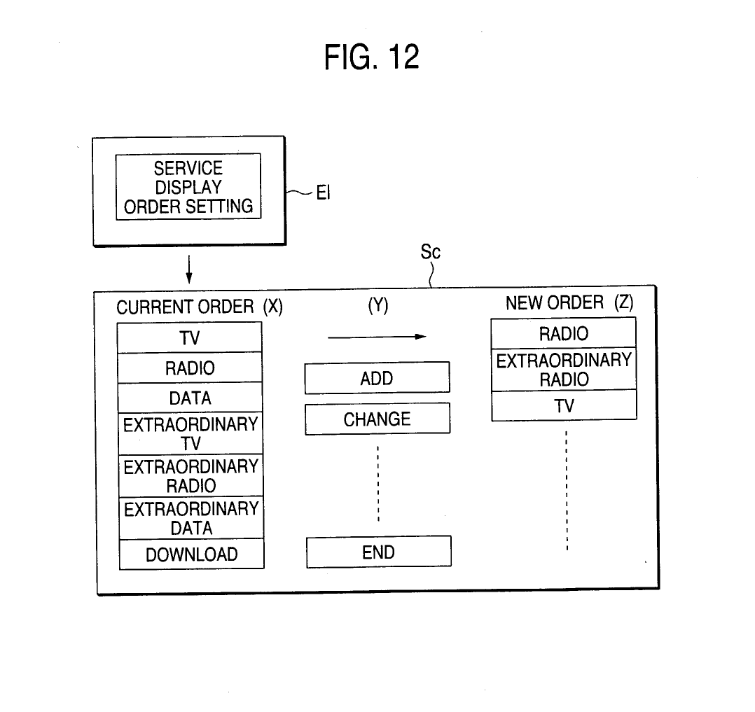

FIG. 12 is a schematic representation to show another embodiment of the invention. In FIG. 12, “Service display order setting” is selected in a selection item El. The current order of the service types displayed in program guide is displayed in a current order field (X) on an operation screen Sc. Next, if change is selected in a (Y) field and predetermined processing is performed, a new order is displayed in a (Z) field. To set the new order, for example, the service types displayed in the current order are selected subsequetly, whereby they can be displayed in the new order in the (Z) field.

To set the new order in FIG. 12, all service types in the current order field (X) need not be contained and only some of the service types may be selected. For example, only the first displayed service type may be specified and the order setting may be terminated. In the example in FIG. 12, any desired service display order can be set, so that a program guide can be prepared for display in response to the taste of the viewer.

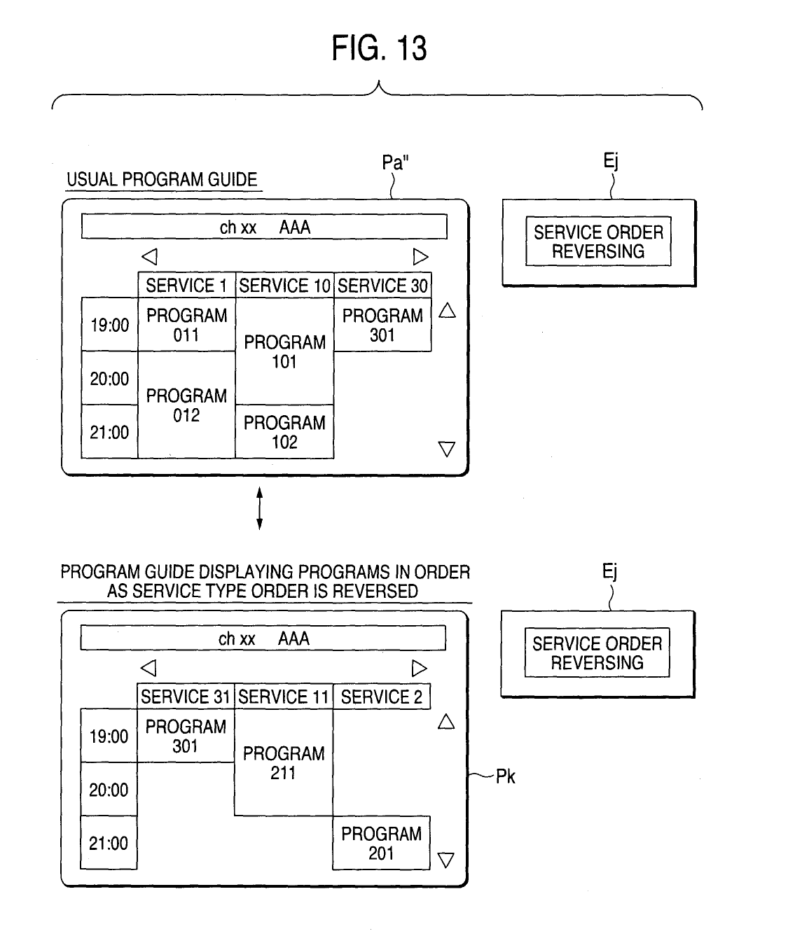

FIG. 13 is a schematic representation to show another embodiment of the invention. In FIG. 13, program guide Pa″ displays the programs of services belonging to the service type TV in the ascending order of the service classification numbers shown in FIG. 4, namely, displays the programs of services 1, 10, and 30 in order. Here, if the viewer selects “service order reversing” of an selection item Ej, the programs are displayed starting at service 31 in the descending order of the service classification numbers in the service configuration in FIG. 4.

In the example, services 11 and 2 belonging to the radio service type, which is the service type of service 31, are selected and the programs of the services are displayed in the descending order. Thus, in FIG. 13, the display order of the service types is reversed for display. Thus, the viewer can easily watch and operate the program guide of service different from the service type being displayed.

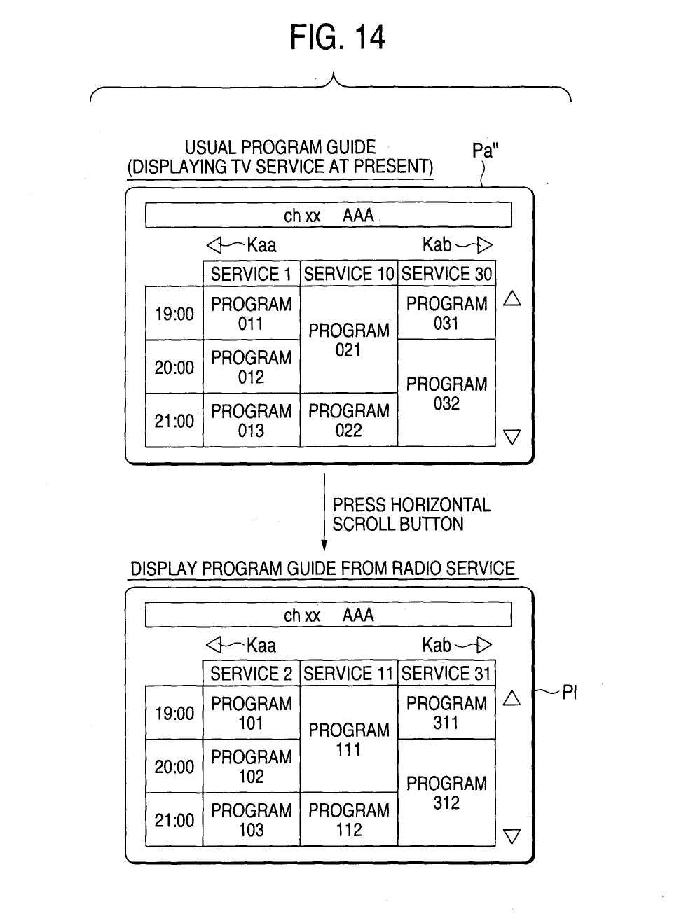

FIG. 14 is a schematic representation to show another embodiment of the invention. In FIG. 14, program guide Pa″ displays the programs of services 1, 10, and 30 belonging to the service type TV like the program guide in FIG. 13. Here, the viewer continues to press a right scroll key Kab for a constant time, for example, several seconds or presses the scroll key Kab twice.

Then, program guide Pl is displayed. In the program guide Pl, display starting at the service type TV in the program guide Pa″ is skipped to the service type radio. The program guide Pl displays radio services of services 2 to 31 of service classification numbers. In the example in FIG. 14, the program guide is skipped for each service type, so that if a plurality of service types exist, the viewer can rapidly watch and operate the program guide.

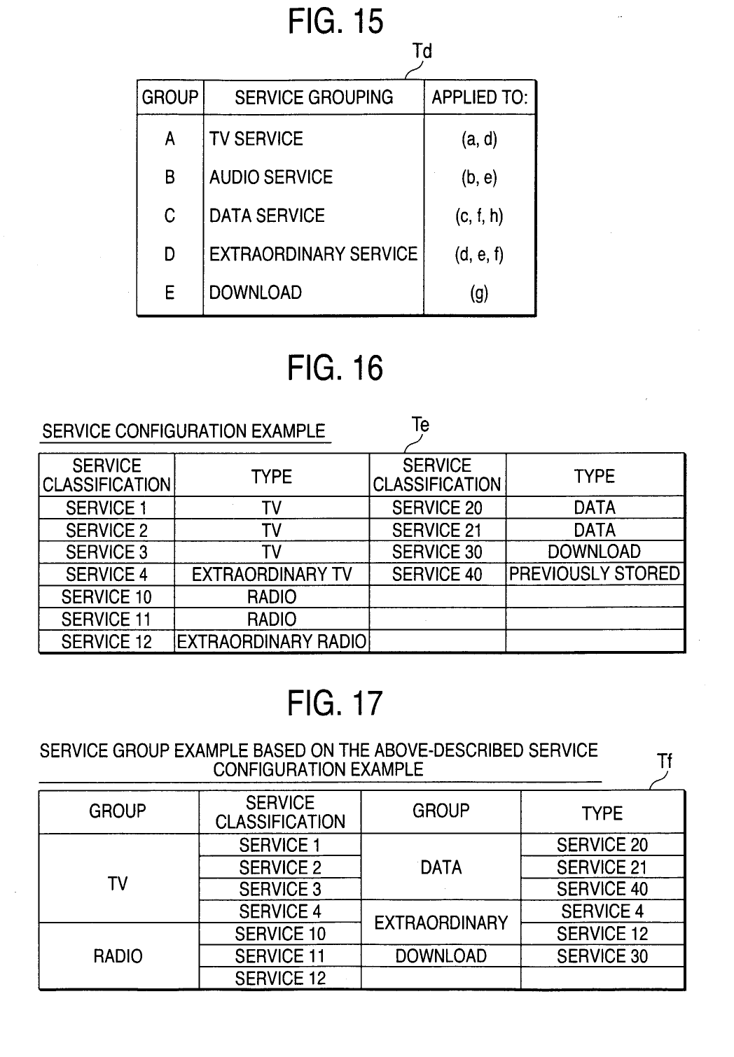

FIG. 15 is a schematic representation to show a table Td of another embodiment of the invention. In FIG. 15, service types are grouped. A to E in FIG. 15 denote group types. For example, group A is TV service and includes a and d in the table in FIG. 2. Group B corresponds to audio service, group C corresponds to data service, group D corresponds to extraordinary service, and group E corresponds to download.

FIG. 16 is a schematic representation to show a table Te as a service configuration example of assigning service classification numbers to services when service groups are formed as shown in FIG. 15. In FIG. 16, services 1 to 4 of the service classification numbers correspond to the service type TV. Services 10 to 12 correspond to the service type radio and services 20 and 21 correspond to the service type data. Further, service 30 corresponds to the service type download and service 40 corresponds to the service type previously stored.

FIG. 17 is a schematic representation to show an example of a table Tf wherein service groups are formed based on the service configuration example in FIG. 16. In FIG. 17, from the table in FIG. 16, services 1 to 4 correspond to the TV service group. Likewise, services 10 to 12 correspond to the radio service group and services 20, 21, and 40 correspond to the data service group. Services 4 and 12 belong to the extraordinary service group and service 30 corresponds to the download service group.

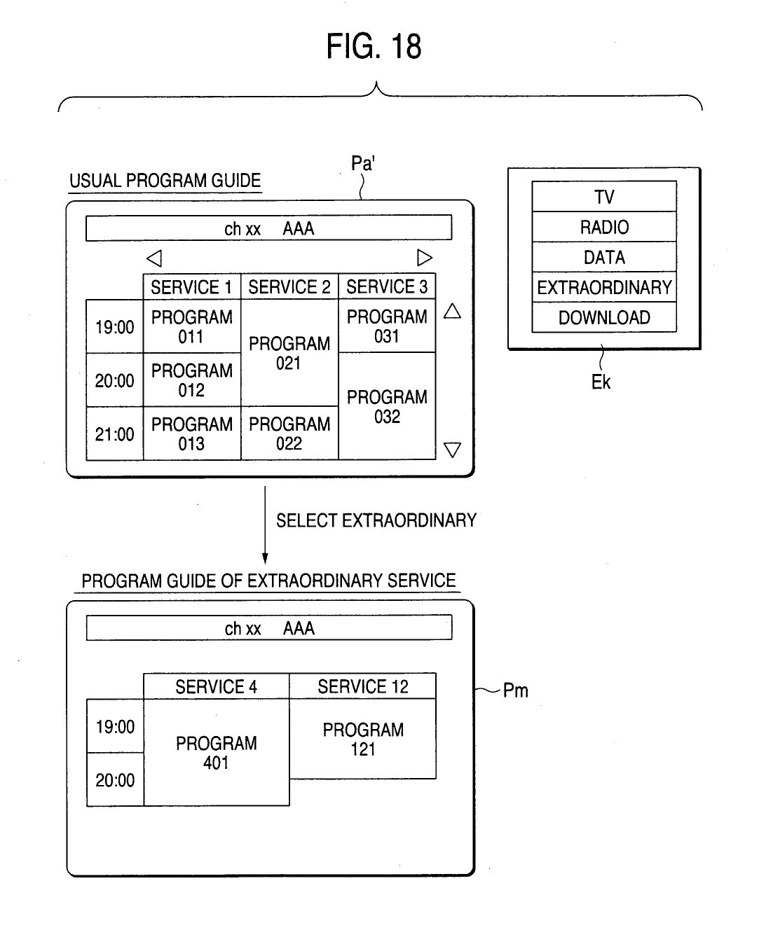

FIG. 18 is a schematic representation to show an example wherein a program guide is edited using a table in which the service types are grouped as in FIG. 17. Assuming that in FIG. 18, the program guide Pa′ is edited based on the service configuration in FIG. 16. In the example, TV programs are displayed in services 1 to 3.

If the viewer selects “Extraordinary” in a selection item Ek on an operation screen, a program guide Pm consisting of services 4 and 12 of the “Extraordinary” service group is displayed in accordance with the table in FIG. 17. The service types are thus grouped, whereby the number of selection items that can be specified can be decreased and the viewer can specify service easily.

In the invention, a program guide easily used by the viewer can be edited using the table in which the service types are grouped as previously described with reference to FIG. 17. For example, a program guide of any other service group than the specified service group can be displayed instead of specifying the service to be not displayed for displaying a program guide as previously described with reference to FIG. 5.

In this case, if the viewer specifies “Radio” in the selection item Ek in FIG. 18, a program guide of any other service group than the radio service group is displayed. Since a program guide in which the services in the service group to be not watched are omitted is thus displayed, the viewer can easily watch and operate the program guide.

A program guide of the services belonging to the service group of the default service on the reception channel can also be displayed instead of displaying the program guide of the default service on the reception channel as previously described with reference to FIG. 6.

For example, if service 10 is the default service in FIG. 17, service 10 corresponds to the service type radio and a program guide of services 10 to 12 belonging to the radio service group is displayed. Since the program guide of the same service group as the default service on the reception channel is thus displayed, the viewer can rapidly watch and operate the program guide of the same service group as the default service.

A program guide of the services belonging to the service group of the service being selected can also be displayed instead of displaying the program guide of the “Station being selected” service (service being selected) as previously described with reference to FIG. 7. For example, if “Data” of service 20 is the service being selected in the table in FIG. 17, a program guide of services 20, 21, and 40 belonging to the data service group is displayed. Since the program guide of the same service group as the service being selected is thus displayed, the viewer can rapidly watch and operate the program guide of the same service group as the service being selected.

Further, display can be switched between the services of the service group being displayed and the services of any other service group than the service group being displayed instead of switching from the service being displayed to any other service than the service being displayed and displaying a program guide as previously described with reference to FIG. 8.

In the example in FIG. 17, the program guide display of the radio service group can be switched to a program guide of the services of any other service group than the radio service group for display, for example. Since the program guide is thus switched corresponding to the service group, the viewer can easily watch and operate program guides for the remaining service groups different from the service group being displayed.

Further, program guides can be displayed in various variations using the table of the service groups as in FIG. 17. As an example, the viewer can select the “Service number order” in the selection item on the operation screen as previously described with reference to FIG. 9 and can display the program guides in order according to the service group.

In the example in FIG. 17, the service groups are “TV,” “Radio,” “Data,” “Extraordinary,” and “Download” and the display order of the service groups can set as desired. Since the program guide arranged for each service group is thus displayed, when the viewer is conscious of the service group and watches and operates the program guide, the convenience of the viewer can be enhanced.

At the display time in the service type order, the technique of displaying the program guide of the services belonging to the same service type as the default service on the reception channel can be applied as previously described with reference to FIG. 10. In this case, the program guides are displayed in order starting at the service belonging to the service group of the default service on the reception channel. For example, it is assumed that service 1 with the smallest service classification number in the table in FIG. 17 is set to the default service on the reception channel.

In this case, the service type of service 1 is “TV” and thus display is started at the program guide of services 1 to 4 belonging to the TV service group. Since display is thus started at the program guide of the services belonging to the same service group as the default service on the reception channel, the viewer can rapidly watch and operate the program guide of the same service group as the default service.

When the services are grouped, the program guide of the services belonging to the service group of the default service is first displayed and then program guides are displayed in order according to the service group. This prevents the viewer from losing sight of the program guide of the services belonging to the service group of the default service.

“Station being selected” is selected in the selection item on the operation screen as previously described with reference to FIG. 11 and the program guides can also be displayed in order starting at the services belonging to the service group of the service being selected. For example, when service 4 is the service being selected in the table in FIG. 17, display is started at the program guide of services 4 and 12 belonging to “Extraordinary” of the same service group as service 4.

Since the program guides are thus displayed in order starting at the services belonging to the service group of the service being selected, the viewer can rapidly watch and operate the services of the same service group as the service being selected. When the services are grouped, the program guide of the services belonging to the service group being selected is first displayed and then program guides are displayed in order according to the service group. Thus, program guide display fitted for the actual state of the program guide operation of the viewer can be produced.

“Service number order” is selected in the selection item on the operation screen as previously described with reference to FIG. 11 and it can be made possible to set the service group order of the program guides to be displayed. Thus, it is made possible to set the service group order of the program guides to be displayed, whereby the program guides can be prepared and displayed in the service group order as requested by the viewer.

“Service order reversing” is selected in the selection item on the operation screen as previously described with reference to FIG. 13 and the service group order of the program guides to be displayed can also be reversed for display. In the table example in FIG. 17, it is assumed that the service groups “TV,” “Radio,” “Data,” “Extraordinary,” and “Download” are displayed in this order, the display order is reversed such as “Download,” “Extraordinary,” “Data,” “Radio,” and “TV.”

Thus, if the services are grouped, the service group order of the program guides can also be reversed for display. The viewer can easily watch and operate the program guide of a different service group from the service group being displayed.

As previously described with reference to FIG. 14, the left or right horizontal scroll key can be used to switch from the program guide of the service group being displayed to the program guide of the service belonging to the next service group for display. In doing so, the program guide is skipped for each service group, so that if a plurality of service groups exist, the viewer can rapidly watch and operate the program guide.

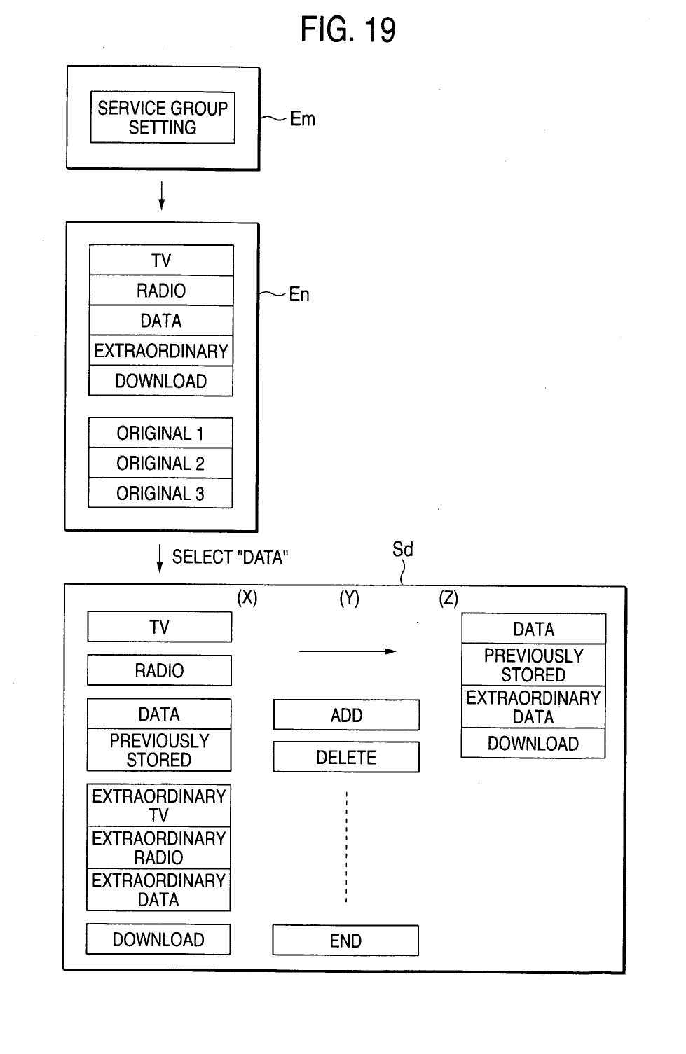

FIG. 19 is a schematic representation to show another embodiment of the invention. In FIG. 19, “Service group setting” of a selection item Em on an operation screen is selected. Then, selection items En are displayed on the operation screen. Here, if the viewer selects selection item “Original 1,” (X) and (Y) fields are displayed on operation screen Sd. When the viewer selects “Data” in the (X) field and “Add” in the (Y) field, the services relevant to “Data” are selected out of the (X) field and are displayed in a (Z) filed.

Since the viewer thus sets the service group by his or her determination in FIG. 19, the viewer can prepare program guides as he or she desires considering the mode required by the viewer, the ease of use, etc.

As described above, according to the invention, there can be provided the program guide display method of the digital broadcast receiver for enabling the viewer to easily watch and operate his or her desired program guide for enhancing the convenience of the viewer.

What is claimed is:

1. A program guide display method of a digital broadcast receiver, the method comprising the steps of:
displaying a program guide of digital broadcast wave, which includes a plurality of service types; and
displaying a program guide of a specified service type, when the service type is specified.

2. A program guide display method of a digital broadcast receiver, the method comprising the steps of:
displaying a program guide of digital broadcast wave, which includes a plurality of service types; and
displaying a program guide of a not-specified service type, when a service type is specified.

3. The method according to claim 1, further comprising the steps of displaying a program guide of a service type, which is a default service.

4. The method according to claim 1, further comprising the steps of displaying a program guide of a service, which belongs to the same service type as a service being selected, when a first button is turned on.

5. The method according to claim 1, further comprising the steps of switching the program guide of the displayed service type to a program guide of the remaining service types, when a second button is pushed.

6. The method according to claim 1, further comprising the steps of displaying the program guide in which the service types are arranged in order, when a third button is pushed.

7. The method according to claim 1, further comprising the steps of displaying a program guide in order, which starts at a service type belonging to a default service, when a fourth button is pushed.

8. The method according to claim 6, further comprising the steps of displaying a program guide of a service, which belongs to the same service type as a service being selected, when a first button is turned on.

9. The method according to claim 6, wherein the display order of the service types at a time the third button is pushed is settable.

10. The method according to claim 6, further comprising the steps of reversing the display order of the service types to display the program guide, when a fifth button is pushed.

11. The method according to claim 6, further comprising the steps of displaying a program guide of a service type being next to the current displayed service type, when a scroll key is operated in accordance with a predetermined rule.

12. The method according to claim 1, further comprising the steps of displaying a program guide of a specified service group, when the service group is specified,
wherein the service group is a group in which a plurality of service types are grouped.

13. The method according to claim 2, further comprising the steps of displaying a program guide of a not-specified service group, when the service group is specified,
wherein the service groups are groups in which a plurality of service types are grouped.

14. The method according to claim 12, further comprising the steps of displaying a program guide in order, which starts at a service group belonging to a default service, when a fourth button is pushed.

15. The method according to claim 12, further comprising the steps of displaying a program guide of a service, which belongs to the same service group as a service being selected, when a first button is turned on.

16. The method according to claim 12, further comprising the steps of switching the program guide of the displayed service group to a program guide of the remaining service groups, when a second button is pushed.

17. The method according to claim 12, further comprising the steps of displaying the program guide in which the service groups are arranged in order, when a third button is pushed.

18. The method according to claim 17, further comprising the steps of displaying a program guide in order, which starts at a service group belonging to a default service, when a fourth button is pushed.

19. The method according to claim 17, further comprising the steps of displaying a program guide of a service, which belongs to the same service group as a service being selected, when a first button is turned on.

20. The method according to claim 17, wherein the display order of the service types at a time the third button is pushed is settable.

21. The method according to claim 17, further comprising the steps of reversing the display order of the service groups to display the program guide, when a fifth button is pushed.

22. The method according to claim 17, further comprising the steps of displaying a program guide of a service group being next to the current displayed service group, when a scroll key is operated in accordance with a predetermined rule.

23. The method according to claim 17, wherein user can set the service group.

24. A digital broadcast receiver comprising:
a central processing unit;
an input section from which user inputs an instruction; and
a display,
wherein the central processing unit makes the display to display a program guide of digital broadcast wave, which includes a plurality of service types; and
the central processing unit makes the display to display a program guide of a specified service type, when the instruction by the user is specification of a service type.

25. The receiver according to claim 24, wherein the central processing unit makes the display to display the program guide in which the service types are arranged in order, when the instruction by the user is a first instruction.

26. The receiver according to claim 24,
wherein the central processing unit makes display to display a program guide of a specified service group, when the instruction by the user is specification of a service type; and
wherein the service group is a group in which a plurality of service types are grouped.

27. The receiver according to claim 24, wherein the central processing unit makes the display to display the program guide in which the service groups are arranged in order, when the instruction by the user is a second instruction.
